(19) United States
(12) Patent Application Publication
(10) Pub. No.: US 2013/0344271 A1
(43) Pub. Date: Dec. 26, 2013

(54) MULTI-LAYER HEAD FOR EXTRUSION DIE ASSEMBLY

(71) Applicant: GUILL TOOL and ENGINEERING Co., Inc., West Warwick, RI (US)

(72) Inventor: Roger GUILLEMETTE, Narragansett, RI (US)

(73) Assignee: GUILL TOOL and ENGINEERING Co., Inc., West Warwick, RI (US)

(21) Appl. No.: 13/871,234

(22) Filed: Apr. 26, 2013

Related U.S. Application Data
(60) Provisional application No. 61/639,034, filed on Apr. 26, 2012.

(51) Int. Cl. B29D 23/00; B32B 1/08

(52) U.S. Cl. CPC B29D 23/00; B32B 1/08
USPC 428/36.91; 425/133.1; 264/171.26

(57) ABSTRACT

A multi-layer extrusion die assembly includes a body, a main bore extending longitudinally through the assembly, a core tube, and a plurality of dies. The extrusion die assembly is configured to receive an input stream of material and divide the input stream into a plurality of material streams. Each die is configured to receive one or more of the material streams and to form a single continuous layer of material about the core tube. The layer formed by each die has one or more weld lines running longitudinally along the layer. The dies are arranged along the core tube such that a plurality of concentric layers of material is formed around the core tube. Each die is rotated axially with respect to adjacent dies such that the weld lines of the layer formed by one die.

### CROSS-REFERENCE TO RELATED APPLICATIONS

This application claims priority to and the benefit of, U.S. Provisional Patent Application Ser. No. 61/639,034 filed on Apr. 26, 2012, the disclosure of which is incorporated herein by reference in its entirety.

### BACKGROUND

1. Field

The aspects of the present disclosure generally relate to extrusion die assemblies, and more particularly to a multi-layer head for an extrusion die assembly and a multi-layer tubing product.

2. Brief Description of Related Developments

In the manufacture of products such as plastic coated wire, rubber coated wire and plastic and rubber tubing, molten plastic and/or rubber is typically extruded by a crosshead extrusion system that receives a stream of molten material (referred to herein as a “material stream”) and causes the molten material to be distributed around the circumference of a wire or in the form of a tube.

It is generally understood that the splitting and re-joining or blending of the material stream causes weld or joint lines in the formed product, where the extruded material is not evenly blended together. The weld or joint lines can form weak spots or failure points in the formed product. Generally, every extrusion head will produce a weld line in the produced product.

Accordingly, it would be desirable to provide a system that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the present disclosure relates to a multi-layer extrusion die assembly. In one embodiment, the multi-layer extrusion die assembly includes a body, a main bore extending longitudinally through the assembly, a core tube, and a plurality of dies. The extrusion die assembly is configured to receive an input stream of material and divide the input stream into a plurality of material streams. Each die is configured to receive one or more of the material streams and to form a single continuous layer of material about the core tube. The layer formed by each die has one or more weld lines running longitudinally along the layer. The dies are arranged along the core tube such that a plurality of concentric layers of material is formed around the core tube. Each die is rotated axially with respect to adjacent dies such that the weld lines of the layer formed by one die.

Another aspect of the present disclosure relates to a multi-layer product. In one embodiment, the multi-layer product includes a plurality of layers of a material formed concentrically about a central axis. Each layer has one or more weld lines running longitudinally along the product, and the weld lines of each layer are offset from the weld lines of adjacent layers.

A further aspect of the present disclosure is directed to a method of making a multi-layer product using an extrusion die assembly. In one embodiment, the method includes receiving a stream of molten material into the extrusion die and dividing the stream of molten material into a plurality of material streams. The material streams are then used to form each layer of the multi-layer product. The material streams used to create each layer are offset by a pre-determined angle such that the weld lines in each layer do not align with the weld lines in adjacent layers.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention. Moreover, the drawings are not necessarily drawn to scale and unless otherwise indicated, they are merely intended to conceptually illustrate the structures and procedures described herein. In addition, any suitable size, shape or type of elements or materials could be used.

### BRIEF DESCRIPTION OF THE DRAWINGS

In the drawings:

FIG. 1 is a cross-sectional view of one embodiment of a cross-head multi-layer extrusion die assembly incorporating aspects of the present disclosure.

FIG. 2 is an end view of the multi-layer extrusion die assembly of FIG. 1.

FIG. 3 illustrates an end view of one embodiment of a multi-layer product formed using a multi-layer extrusion die assembly incorporating aspects of the present disclosure.

FIG. 4 illustrates an end view of an exemplary input plate incorporating aspects of the present disclosure.

FIGS. 5-8 illustrate end views of exemplary supply plates for a multi-layer extrusion die assembly incorporating aspects of the present disclosure.

FIG. 9 illustrates a front view of an exemplary splitter die plate incorporating aspects of the disclosed embodiments.

FIG. 10 illustrates one embodiment of an inline multi-layer extrusion die assembly incorporating aspects of the present disclosure.

FIGS. 11 and 12 illustrate the use of interlocking devices in a multi-layer product incorporating aspects of the disclosed embodiments.

FIG. 13 illustrates the use of alternating spirals in a multi-layer product incorporating aspects of the disclosed embodiments.

FIG. 14 illustrates a flow chart for an exemplary process for creating a multi-layer product incorporating aspects of the present disclosure.

### DETAILED DESCRIPTION OF THE EXEMPLARY EMBODIMENTS OF THE DISCLOSURE

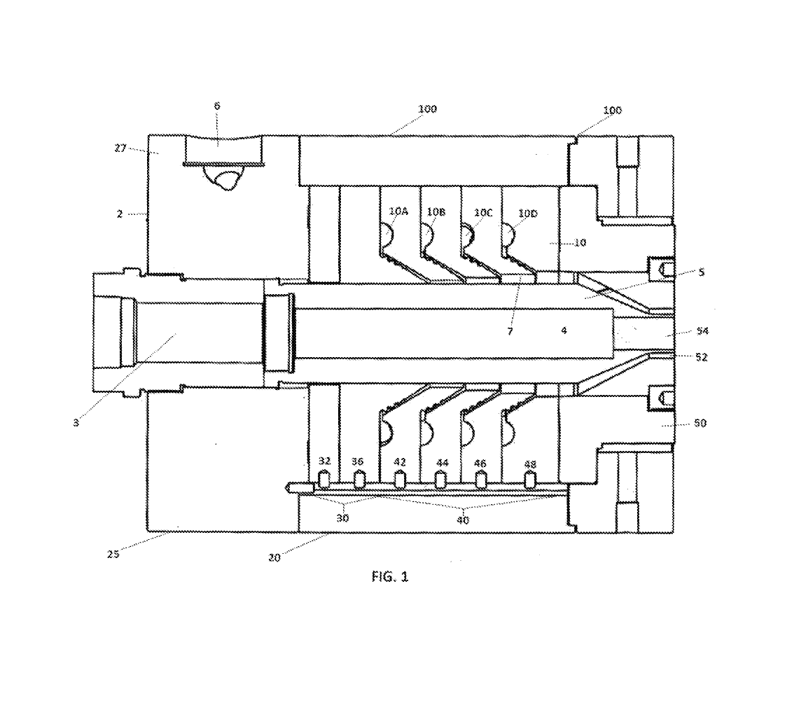

Referring to FIG. 1, a cross-sectional view of an exemplary multi-layer extrusion die assembly incorporating aspects of the disclosed embodiments is generally designated by reference numeral 100. The aspects of the disclosed embodiments are directed to a multi-layer cross head assembly for an extrusion die system. The multi-layer extrusion die assembly of the disclosed embodiments is configured to form a multi-layer product, such as a tube or bottle, or to form multi-layer insulation on a wire, where the weld joints of each adjacent layer are offset from one another and overlapped by each adjacent layer. The aspects of the disclosed embodiments advantageously provide a multi-layer product that is stronger than conventional multi-layer tubing and film products, and can be produced using less material and without the need for expensive equipment and retooling.

As is shown in FIG. 1, the extrusion die system 100 generally includes a body 2, a main bore 3 extending longitudinally through the body and a core tube 5. An inlet 6 is split into two substantially equal flow channels 11 and 12 which distribute the molten material to a series of passageways 10A-10D, also referred to as a spider assembly 10.

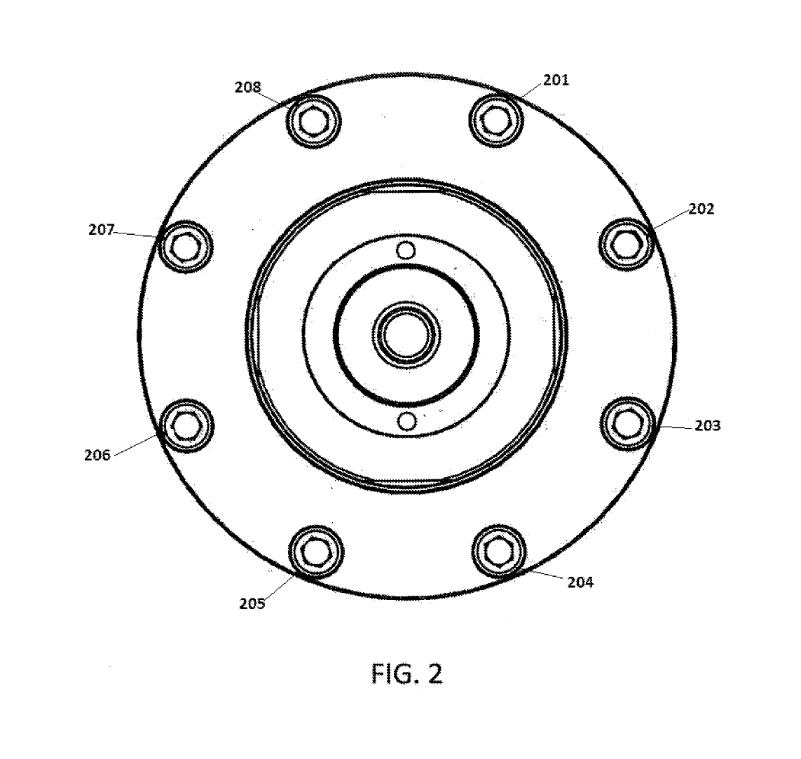

In the example shown in FIG. 1, the extrusion die system 100 includes a die assembly 20, also referred to as a longitudinal multi-plate extrusion head assembly 20. The extrusion head assembly 20 generally comprises a multi-plate extrusion head including input plate assembly 25, supply plate assembly 30, and splitter die plate assembly 40, and tip die assembly 50. The plate assemblies 25, 30, 40 and 50 are assembled together in any suitable manner, such as by bolts 201-208 illustrated in FIG. 2. As used herein, the directional indicators front, forward, next, and subsequent are used to indicate positions closer to the tip 52 where material exits the assembly 100. Similarly directional indicators back rear and previous and preceding are used to indicate positions close to the inlet 6.

The longitudinal multi-plate extrusion head assembly 20 is generally divided into four zones. The first zone 25 is the input zone and includes the material flow inlet channel 6 and input plate 27. The second zone 30 is the supply zone, where the material flow is divided and split into a number of separate material streams corresponding to the respective layers as determined by the number of supply plates, which in this example includes plates 32 and 36. Although the aspects of the disclosed embodiments will be described herein with respect to a four-layer cross-head, in alternate embodiments, the die assembly 20 can be configured for any suitable number of layers including more or less than four, such as for example 2, 3, 5 or more layers. In certain embodiments it is desirable to create an extrusion die assembly having, for example, 32 layers. The third zone is the splitter die zone 40 where the material streams created in the supply zone 30 are split and formed into layers of material around the core tube 5 by a series of splitter die plates 42, 44, 46, and 48. The last zone is the tip 50 which include tip die 51. The supply plates 32 and 36 include diverging channels that split the flow of material into different streams, which, as will be described in more detail below, are received by the splitter die plates 42, 44, 46, and 48 and formed through passages 10 into layers 7 around the core tube 5. In one embodiment, the circumferential positions of the multiple streams are staggered between layers by rotating the material streams of each subsequent supply plate 32, 36, and associated splitter die plate 42, 44, 46, and 48, relative to the prior plate.

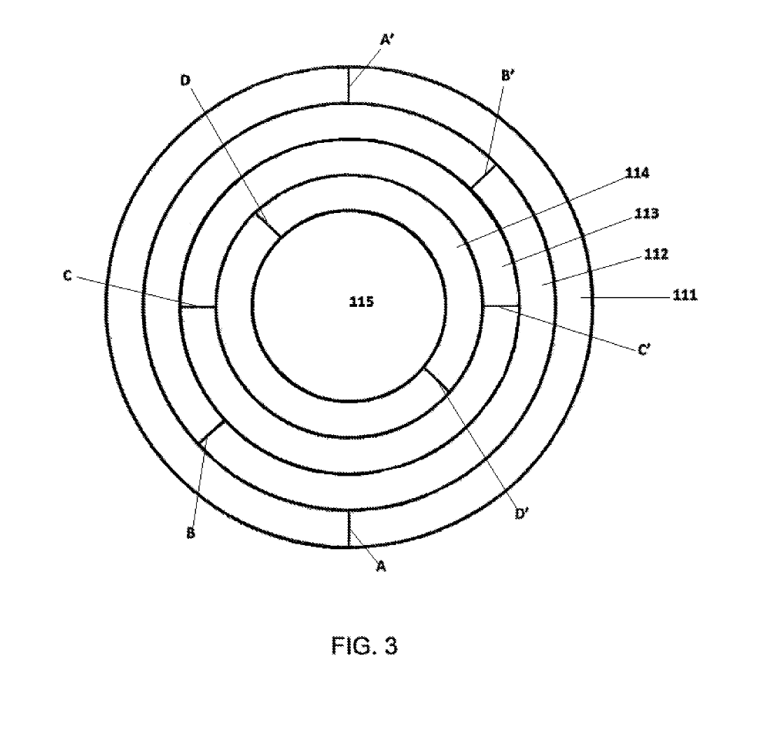

FIG. 3 illustrates one embodiment of a multi-layer product 115 formed by a multi-layer extrusion die assembly 100 incorporating aspects of the disclosed embodiments. In this example, the product 115 is a four layer product, and includes a first layer 111, second layer 112, third layer 113 and fourth layer 114. As is shown in the illustration, each layer 111-114 includes weld lines or joints, generally referred to by references A, A′, B, B′, C, C′, and D, D′, where the molten material rejoins within the splitter die plates. The aspects of the disclosed embodiments stagger or offset the material flow of each adjacent layer from one another. Thus the weld lines in each of the layers 111-114 will be overlapped by the adjacent layer and will not line up in a radial direction. In other words, each subsequent layer will cover the weld lines in the preceding layer, with the weld lines of in-between layers being overlapped by both the preceding and next layer, where the weld lines in each layer are offset from one another. Thus, the exemplary four layer product will include three layers covering one. An eight layer product will include seven layers covering one.

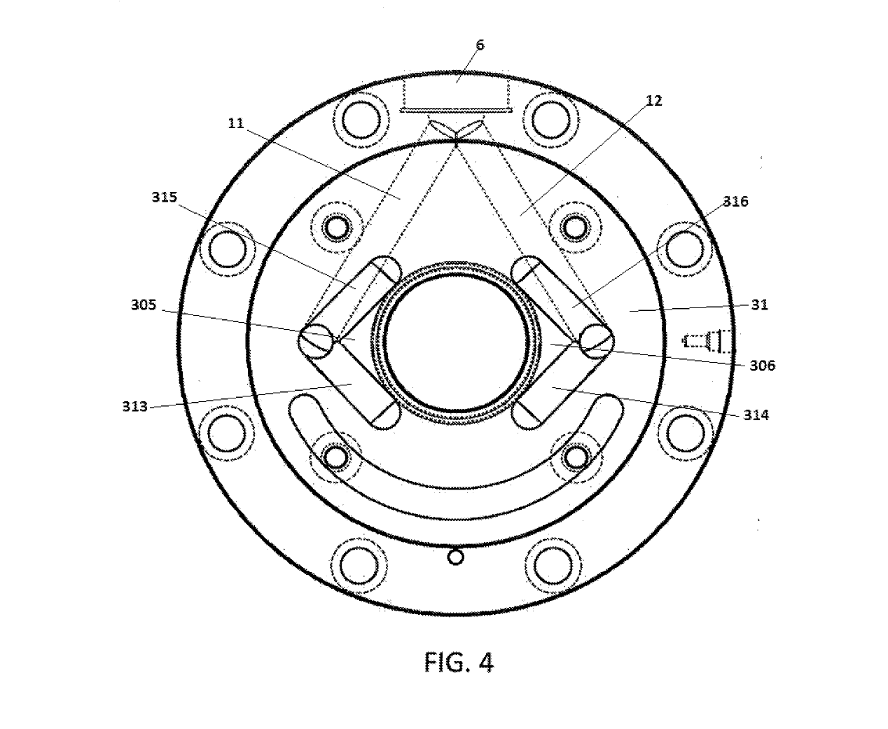

Referring to FIGS. 4-7, the extrusion head assembly 20 is generally a balanced flow system starting with supply inlet 6 shown in FIGS. 1 and 4. Referring now to FIG. 4, there can be seen an axial view of an exemplary input plate 27. Material, such as molten plastic or other thermoset material, enters under pressure from extruders, not shown, through inlet 6 and is split and diverted forward and exits the input plate 27 through ports 11 and 12 located on the forward side wall 31 of input plate 27. Upon exiting through ports 11 and 12, the material stream is split into four substantially equal material streams in passages 313, 315, and 314, 316 respectively. In certain embodiments wedges 305 and 306 are formed between passages 313 and 315, and passages 314 and 316 respectively to encourage splitting of the material streams. The flow splitters 305, 306 evenly divide the flow stream of molten material from the respective flow channels into the flow channels 313, 315 and 314, 316, respectively. An extrusion assembly 100 where the inlet port 6 is on the side of the assembly as shown in extrusion assembly 100 is known as a cross head. Alternatively, the supply plate 27 can be configured to receive material through an inlet port aligned axially in line with the main bore 3. Extrusion assemblies configured with an inline inlet port are known as inline heads.

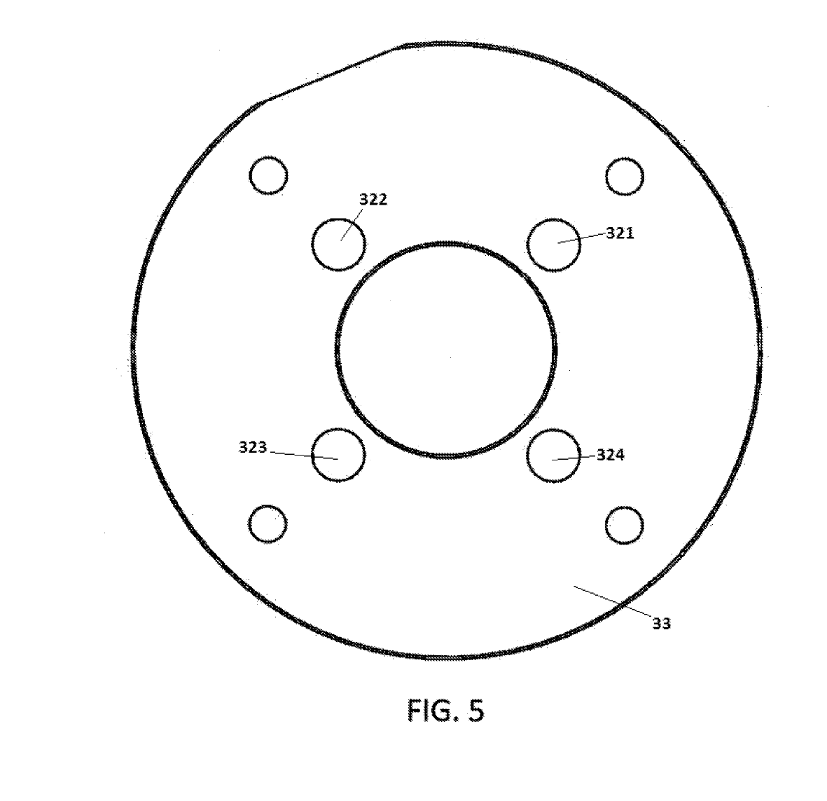

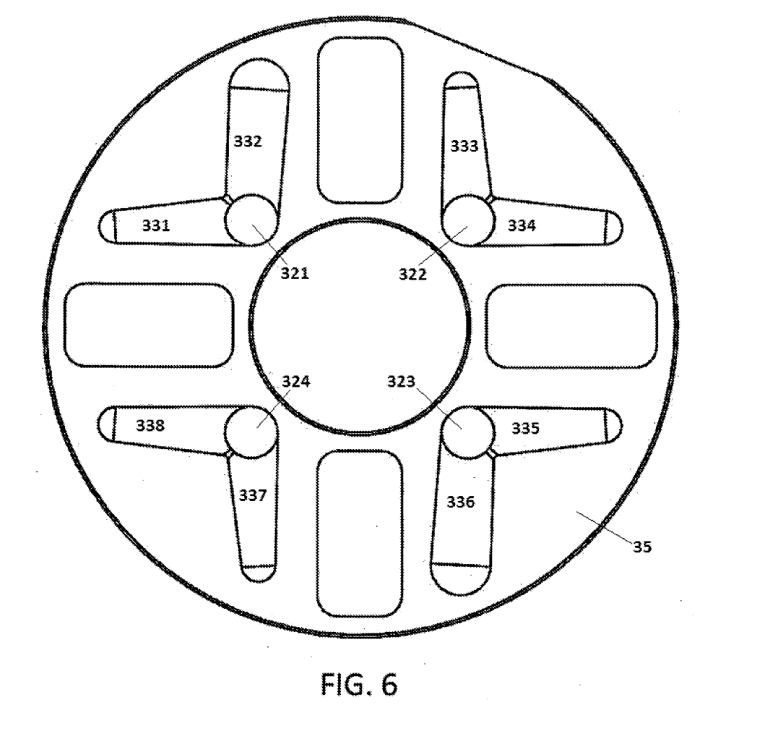

Material exiting the input plate 27 then enters supply plate 32, shown in axial view in FIG. 5, through ports 321, 322, 323, and 324 in rear side wall 33 of the supply plate 32 which is in fluid communications with channels 313, 314, 315, and 316 on the front side wall of input plate 27. The material streams flowing in through ports 321, 322, 323, and 324 are then split into eight substantially equal material streams in channels 331-338 on the front side wall 35 of supply plate 32, shown in axial view in FIG. 6.

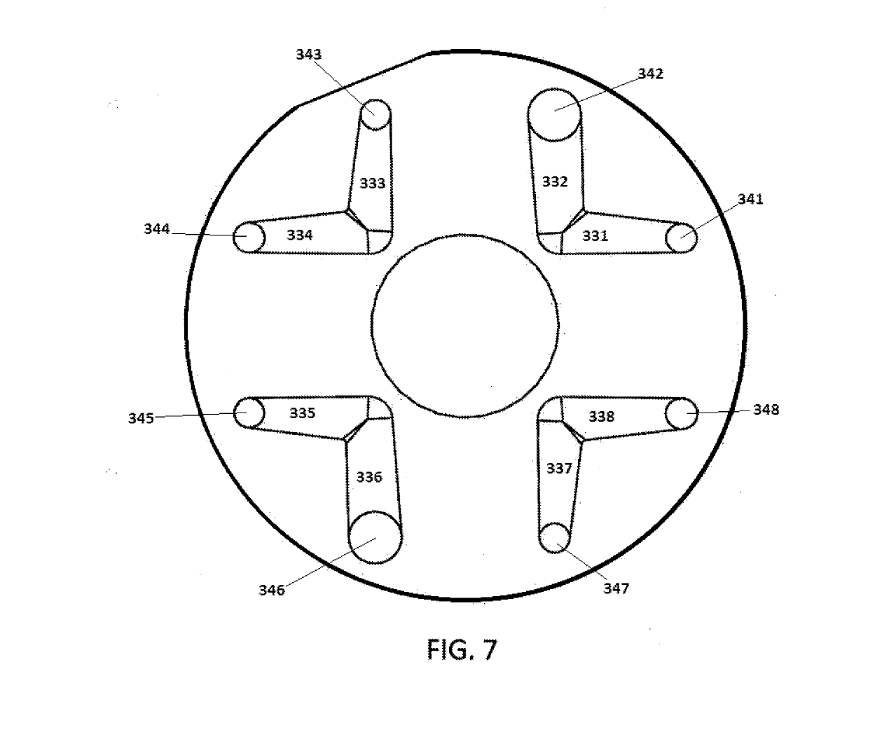

FIG. 7 illustrates the rear side wall 37 of an exemplary supply plate 36 configured to split material streams entering through ports 321, 322, 323, and 324 into eight substantially equal material streams which exit supply plate 36 through ports 341-348. A material stream entering through port 321 in the rear side of 33 of supply plate 32 is symmetrically divided into two material streams flowing in passages 331 and 332 to exit the supply plate 36 through ports 341 and 342. Similarly material streams entering through ports 322, 323, and 324 are symmetrically divided into pairs of channels 333-334, 335-336, and 337-338 respectively. When the flow channels 331, 332, 333, 334, 335, 336, 337 and 338, reach their respective openings 341, 342, 343, 344, 345, 346, 347 and 348 they turn forwardly and open outwardly into the respective openings 341-348 formed in the second end wall 39. In configurations where more than four layers are required, additional supply plates 30 can be utilized to further divide the incoming flow stream, as is otherwise described herein.

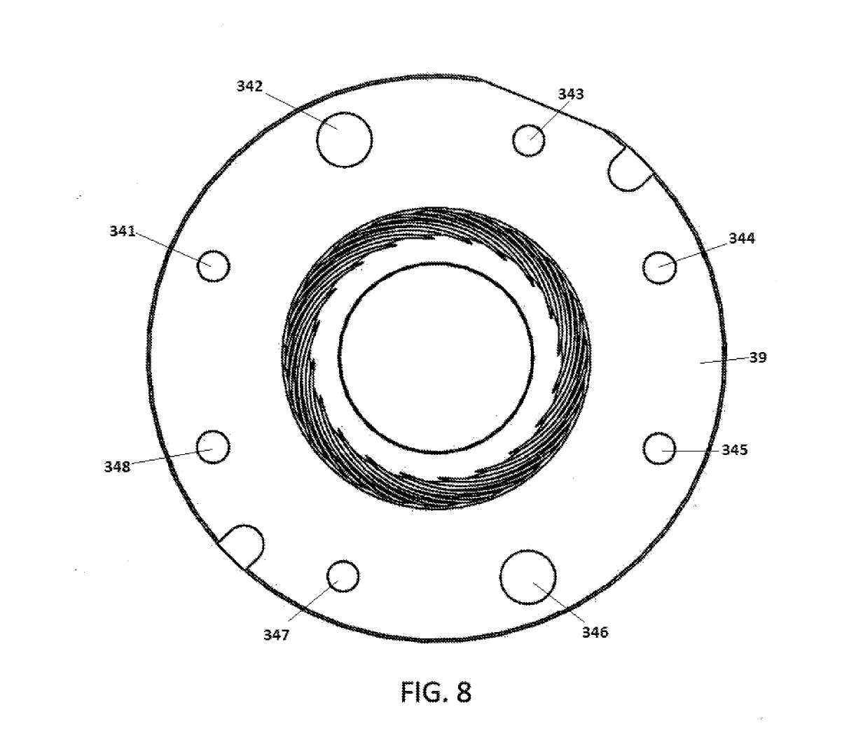

FIG. 8 illustrates front side 39 of the second supply plate 36. The openings 341-348 generally form pairs, 341:345, 342:346, 343:347, and 344:348, of opposing pairs of openings, where each pair of openings is offset from an adjacent pair of openings by approximately 45 degrees, in this example of a four layer extrusion crosshead. It will be understood, that in other multi-layer arrangements, such as two layers or eight layers, the openings will be suitably offset.

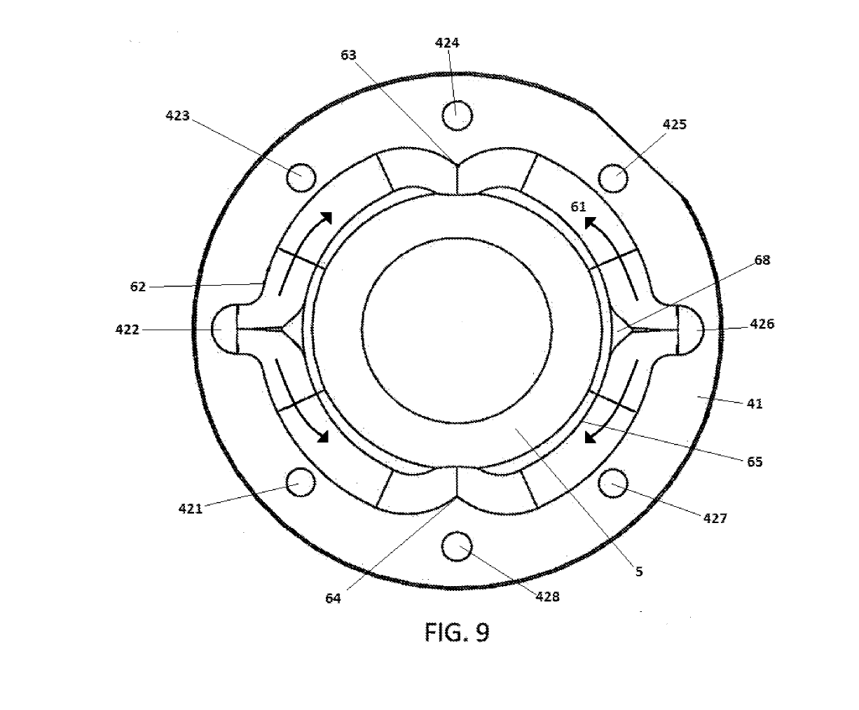

As is shown in FIG. 9, the rear side 41 of first splitter 42 includes openings 421, 423, 424, 425, 427, and 428. Openings 421, 423, 424, 425, 427, and 428 in the rear side 41 of first die plate 42 are configured to align with openings 341, 343, 344, 345, 347, and 348 respectively in the second side 39 of the second supply plate 36. Each splitter die 42-48 is configured to provide a separate material flow, one for each layer of the multi-layer product being formed. Rear side 41 of the first splitter die 42 is configured to form the first layer of the multi-layer product from the material flow. In this example, the opposing pair of openings 342 and 346 are selected on the front side 39 of second supply plate 36 to form the first layer. Each opening 342, 346 receives a flow of molten material. The openings 422 and 426 are in fluid communication with openings 342 and 346 respectively on front side 39 of second supply plate 36. Groove 61 is formed in the rear end 41 of the splitter plate 42. The openings 422, 426 are positioned approximately one hundred and eighty degrees apart from one another along the groove 61. The groove 61 has an upstream circumferential edge 62 in which are constructed two substantially symmetrically placed blending wedges 63, 64 extending into the groove 61 to encourage movement of the molten plastic in the groove 61 radially inward. In one embodiment, the wedges 63, 64 are arranged equidistant from the openings or inlets 422, 426. The downstream edge 65 of the groove 61 can include a flat land 66 merging into the surface of core tube 5. To enhance the distribution function of the groove 61, the land 66 is constructed of gradually diminishing width in each direction, away from the inlets 422, 426, so that the downstream edge 65 merges directly into the surface 5 opposite the blending wedges 63, 64, and operates to restrict the flow of molten material over the downstream edge 65 at the inlets 422, 426.

The molten material, such as molten thermo-plastic, is introduced to the groove 61 symmetrically by the flow channels feeding the respective openings 422, 426. The material flow diverges in opposite directions around the groove 61 as shown by the arrows in FIG. 9. Since the downstream edge 65 is of lesser height than upstream edge 62, the molten material flows over the downstream edge 65 to the surface of core tube 5. Because of the extended width of the land 66 of the downstream edge 65 in the vicinity of the openings 422, 426, the molten material flow over the downstream edge 65 is restricted at the inlet and the groove 61 tends to fill with the molten material. The flow of molten material tends to extend evenly over the downstream edge 65 to create an even distribution of molten material in the extrusion passage 7 shown in FIG. 1. Blending wedges 63, 64 tend to direct the flow of material over the downstream edge 65 at its thinnest area, further enhancing the balanced distribution of the molten material. Subsequent splitter die plates will have distribution grooves that are substantially identical in structure to the first distribution groove 61 of the splitter die 42. The corresponding opening pairs, positioned approximately 180 degrees apart, will be rotated or offset at an angle from the previous opening pairs so that when the subsequent layer of the multi-layer product is formed, the weld lines of the previous layer will be covered by the next layer. The amount of rotation or angle can be dependent upon the number of layers of the multi-layer product. For example, in a four-layer product, the opening pairs can be offset by 45 degrees, while for an eight layer product the opening pairs can be offset or rotated 22.5 degrees for each layer.

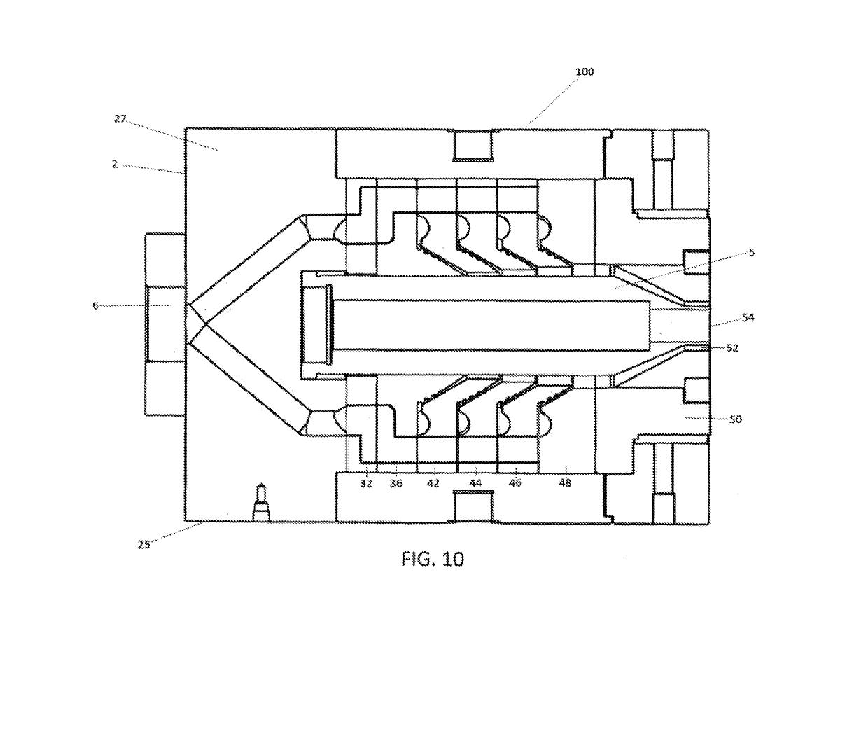

FIG. 10 illustrates another example of an extrusion die assembly 102 incorporating aspects of the disclosed embodiments. In this example, the inlet 6 from the extruder (not shown) to the extrusion die assembly 102 is inline. In this example, the supply die 36 can be excluded.

Referring to FIG. 10, the tip die assembly 50 is generally configured to receive a balanced flow of four streams of extruded plastic, where the weld lines of adjacent layers are covered by the subsequent layer. Thus, the weld lines of the final multi-layer product are staggered or offset, with the weld lines in each layer covered by the body portion or material of another layer. The weld lines in the product produced in accordance with the aspects of the disclosed embodiments do not align as is the case in a typical multi-layer extrusion die head and product. This advantageously provides added strength to the multi-layer product.

In the disclosed embodiments supply plates 32, 36 were used to distribute material to each of the four layers and all four layers are formed of the same material. In certain embodiments, each layer may be formed from a different material. In these embodiments, the die may have separate inlets 6 for each material, and the splitter plates will be configured to distribute material to the desired layer. Alternatively, two or more layers can be formed from the same material and the remaining layers can be formed from other materials, or any combination of materials can be used for the different layers.

The exemplary embodiments described above offset the weld lines at equal angles. Alternatively, the weld lines can be offset at varying angles to account for varying layer thicknesses or different characteristics of materials used in the various layers.

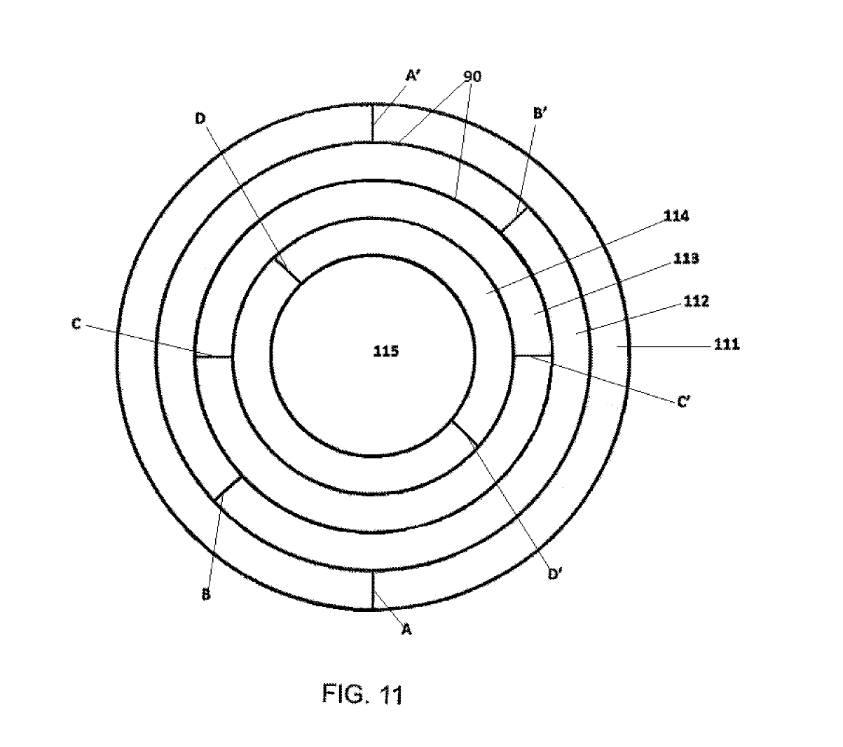

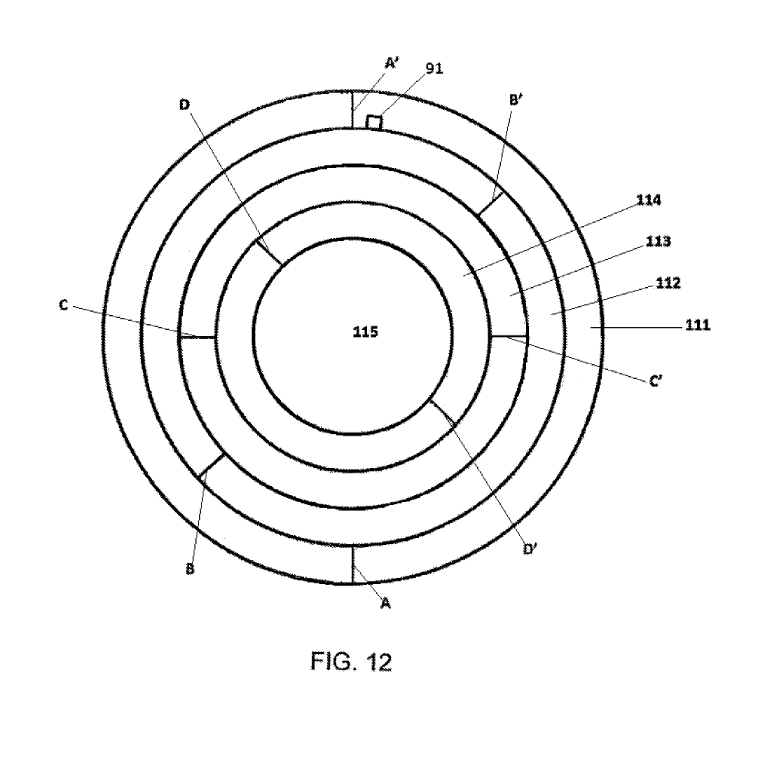

Referring to FIGS. 11 and 12, in one embodiment, the aspects of the disclosed embodiments can include an interlocking device 90, 91 that causes the adjacent layers to lock, or hang together. For example, a notch or dovetail 90 on the cone will cause the adjacent layers to lock together so that one layer cannot turn or rotate independently of another layer. The interlocking device can be any suitable shape, such as a “V” shape or dovetail shape 90 as shown in FIG. 11 or a square key 91 as shown in FIG. 12, or any other suitable device that will prevent the layers from rotating with respect to each other.

The aspects of the disclosed embodiments can generally be applied in any film, tubing and piping applications. Examples of such applications can include, but are not limited to, medical tubing, cosmetic tubing and containers, thin wall tubing, heavy wall piping, rod and solid core applications, blow molding, blown film and automotive tubing applications, or wire insulation applications. It is also possible to provide an overall greater wall thickness as well. Furthermore, since the weld lines of each layer are rotationally offset from one another, it becomes more difficult to detect or see the weld lines in the final product. This is particularly true when using materials that are colored or include speckled or otherwise patterned or marked regions or layers. The rotationally offset weld lines do not build on one another, making them more difficult to detect in the final product. The weld lines in a product produced in accordance with the disclosed embodiments tends to blend the weld lines in, making them less visible to the naked eye.

In one embodiment, when using materials of different viscosities for different layers in a multi-layer product, the aspects of the disclosed embodiments will produce a product in which the different layers are of a more even thickness. It will generally be understood, that when using materials of different viscosities, lower viscosity materials will flow easier than heavier viscosity materials. Thus, when developing a multi-layer product, heavier viscosity materials have a tendency to be held back by the flow dam, pushing the flow to the sides or ends. The build-up of the material in the formed layer can be thicker on the sides relative to the middle. Past practices have including adjusting the height of the flow dam to account for the heavier viscosity materials. However, the aspects of the disclosed embodiments will produce layers that are positionally or rotationally offset from one another. Thus, the thicker areas of each layer will not necessarily align with each other. Since there is a rotational offset from layer to layer, the different thickness that might result will be located in different regions from one layer to the next. This can result in a final product configuration with a more uniform or balanced final thickness, with thicker areas of one layer aligning at least partially with thinner areas of a prior or next layer. Additionally, if a low spot develops in one layer, the following layer will have a tendency to fill in the low spot.

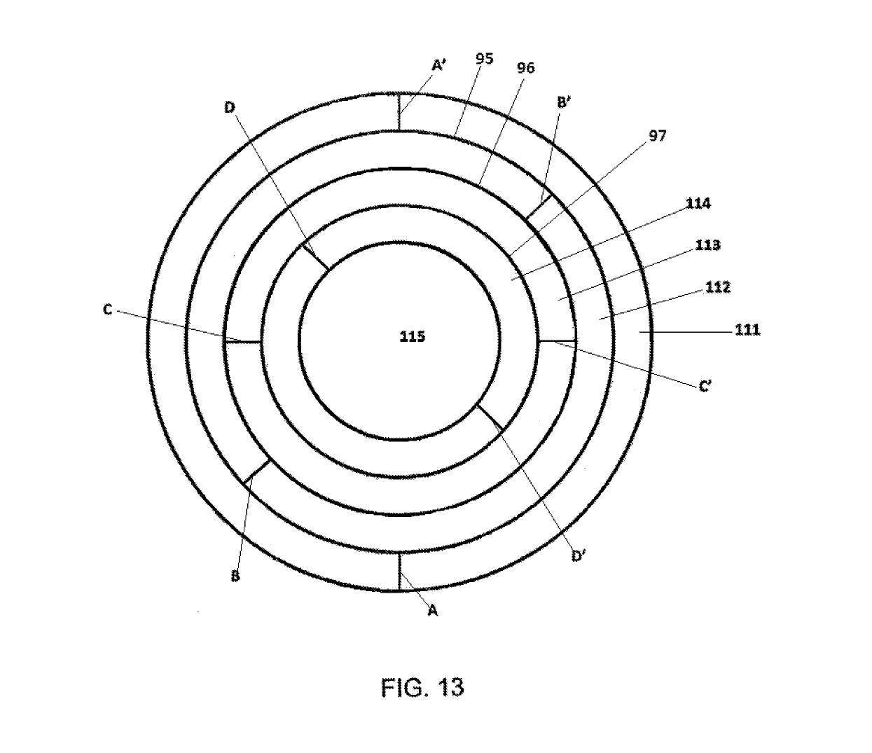

It is also possible to impart spirals or spiraled layers into a product formed in accordance with the aspects of the disclosed embodiments. In one embodiment, the different layers of the formed product are rotationally offset from one another as described herein. Additionally, each layer can be angled in different directions, for example one to the left, and the other to the right. This will cause the layers in the resulting product to form spirals about the longitudinal axis of the product, which can provide additional strength aspects. FIG. 13 illustrates an example of a left hand spiral 95, a right hand spiral 96 and another left hand spiral 97.

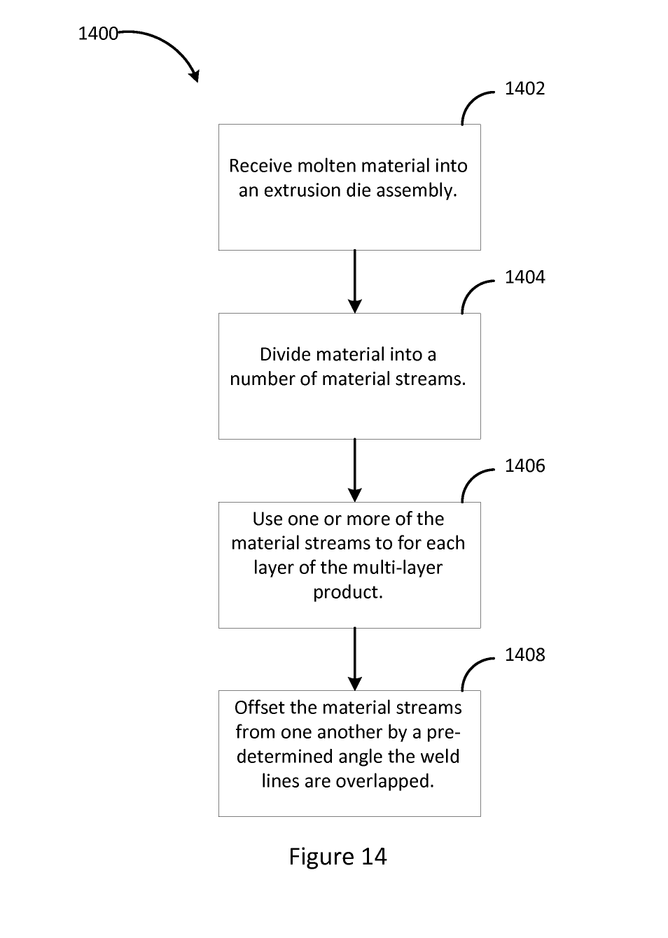

Referring now to FIG. 14 there is illustrated a flow chart for an exemplary process 1400 of producing a product in accordance with the disclosed embodiments. The process begins by receiving a stream of molten material into an extrusion die assembly 1402 such as the extrusion die assembly 100 as shown in FIG. 1 or other suitable extrusion die assemblies. The material is then divided into a number of flow streams or material streams 1404. The number of material streams corresponds to the number of material streams used to create layers in the multi-layer product. One or more of the flow streams are then used to form each layer of the multi-layer product 1406 such as the exemplary multi-layer product illustrated in FIG. 2 or other desired multi-layer product. The material stream streams used to form each layer are offset by a pre-determined angle from material streams used to form adjacent layers 1408 such that weld lined formed in each layer where the molten material comes together are offset form weld lines in adjacent layers. This produces a multi-layer product where the weld lines of each layer are offset or staggered from one layer to another. Each layer overlays the weld lines of prior layers so the weld lines of the multi-layer product do not align with each other.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

1. A multi-layer extrusion die assembly, the assembly comprising:
a body;
a main bore extending longitudinally through the assembly;
a core tube; and
a plurality of dies, wherein the extrusion die assembly is configured to receive an input stream of material and divide the input stream into a plurality of material streams, and
wherein each die of the plurality of dies is configured to receive one or more of the plurality of material streams and to form a single continuous layer of material about the core tube, the layer having one or more weld lines running longitudinally along the layer, and
wherein the plurality of dies are arranged along the core tube such that a plurality of concentric layers of material is formed around the core tube, and
wherein each die of the plurality of dies is offset by a pre-determined angle with respect to adjacent dies such that the weld lines formed by one die are offset with respect to weld lines formed by adjacent dies.

2. The extrusion die assembly of claim 1, wherein each die is configured to receive two streams of material and form a layer having two weld lines.

3. The extrusion die assembly of claim 1, wherein one or more of the plurality of dies is configured to form an interlocking device on the surface of the layer formed by that die.

4. The extrusion die assembly of claim 3, wherein a shape of the interlocking device is a square key, a dovetail or a “V”.

5. The extrusion die assembly of claim 1, wherein the assembly is configured to receive a plurality of input streams of material and each of the plurality of dies is configured to receive material from one of the plurality of input streams.

6. The extrusion die assembly of claim 1, wherein the plurality of dies comprises 4 dies and the assembly is configured to produce a tubular product having four concentric layers.

7. The extrusion die assembly of claim 1, wherein one or more of the plurality of dies is configured to form weld lines that spiral about a central axis of the product.

8. The extrusion die assembly of claim 1, wherein two or more of the plurality of dies is configured to form weld lines that spiral about a central axis of the product and at least one of the two or more dies forms spirals in the opposite direction of another of the two or more dies.

9. A multi-layer product, the product comprising:
a plurality of layers of a material formed concentrically about a central axis,
wherein each layer has one or more weld lines running longitudinally along the product, and the weld lines of each layer are offset from the weld lines of adjacent layers.

10. The multi-layer product of claim 9, comprising a central core wherein the central core is hollow.

11. The multi-layer product of claim 10, wherein the central core comprises the same material as the innermost layer forming a solid rod.

12. The multi-layer product of claim 10, wherein the central core comprises a different material.

13. The multi-layer product of claim 9 wherein each layer comprises two weld lines.

14. The multi-layer product of claim 9, wherein the inner layers are covered by an outermost layer and wherein an interlocking device is formed on the outer surface of each of the inner layers.

15. The multi-layer product of claim 14 wherein a shape of the interlocking device comprises a square key, a dovetail or a “V”.

16. The multi-layer product of claim 9 further comprising a plurality of materials,
wherein each of the plurality of layers comprises one of the plurality of materials.

17. The multi-layer product of claim 9 wherein the weld lines of one or more of the plurality of layers form spirals about the central axis.

18. The multi-layer product of claim 17 wherein a first set of one or more of the plurality of layers form left-hand spirals and a second set of one or more of the plurality of layers form right hand spirals.

19. A method for making a multi-layer product using an extrusion die assembly, the method comprising:
receiving a stream of molten material into the extrusion die assembly;
dividing the stream of molten material into a plurality of material streams;
using one or more of the plurality of material streams to form each layer of the multi-layer product; and
offsetting the material streams used to create each layer by a pre-determined angle such that the weld lines in each layer do not align with the weld lines in adjacent layers.

20. The method of claim 19, comprising forming an interlocking device on a surface of a layer.
